(19) United States
(12) Patent Application Publication
(10) Pub. No.: US 2011/0259185 A1
(43) Pub. Date: Oct. 27, 2011

(54) LETHAL THREAT PROTECTION SYSTEM FOR VEHICLE

(75) Inventors: Thomas Matthew Berning, Maineville, OH (US); George E. Bryant, West Chester, OH (US); Todd Michael Kroeger, Hamilton, OH (US)

(73) Assignee: BAE Systems Survivability Systems, L.L.C., Fairfield, OH (US)

(21) Appl. No.: 12/887,842

(22) Filed: Sep. 22, 2010

Related U.S. Application Data
(60) Provisional application No. 61/246,423, filed on Sep. 28, 2009.

(51) Int. Cl. F41H 7/04; F41H 7/02; B23P 17/04; F41H 5/04

(52) U.S. Cl. 89/36.02; 29/401.1; 89/911; 89/930; 89/937; 89/912

(57) ABSTRACT

A lethal threat protection system for a vehicle, each side of the vehicle having an A pillar and a B pillar and a vehicle body positioned outwardly of the A pillar and the B pillar, the vehicle including a rocker panel area below and spanning between the A and B pillars and including a roof line area above and spanning between the A and B pillars, comprises a perimeter inner layer adapted to be mounted to the vehicle body and comprising an inner monolithic ballistic metal plate having a door opening and including portions adapted to overlie the A pillar, the B pillar, the rocker panel area, and the roof line area, a perimeter outer layer removably mounted to the perimeter inner layer and comprising an outer monolithic ballistic metal plate having a door opening and including portions overlying the portions of the inner monolithic ballistic metal plate, the perimeter outer layer further comprising ballistic fiber secured to an inner surface of the outer monolithic ballistic metal plate, and an armored door mounted to the outer monolithic ballistic metal plate.

### RELATED APPLICATIONS

This application is a nonprovisional of, and claims the benefit of, provisional application Ser. No. 61/246,423, which is hereby incorporated by reference herein as if fully set forth in its entirety.

### FIELD

The subject matter herein relates generally to armoring, and more particularly to an armoring system for military land vehicles.

### BACKGROUND

Military operations require many different types of land vehicles. One type of military land vehicle is a high speed, high mobility, reconnaissance vehicle, for example, a High Mobility Multipurpose Wheeled Vehicle (“HMMWV”). Military land vehicles may encounter various types of lethal threats, for example, ballistic threats, explosive threats, etc. Ballistic threats are presented by bullets and other projectiles; explosive threats are presented by anti-tank mines, anti-personnel mines, claymores, improvised explosive devices (“IED's”), explosively formed penetrators (“EFP's”), etc.

It is known to armor a perimeter of a vehicle to protect it from ballistic threats and to provide an underbody of the vehicle with blast shields to protect it from explosive threats. Lethal threat protection systems using combinations of armor and blast shields have heretofore been developed for the HM Two such systems are shown and described in the assignee's U.S. Pat. Nos. 5,663,520 and 5,533,781, hereby incorporated by reference herein. The lethal threat protection systems of these two patents are permanently applied to the vehicle. In other words, the lethal threat protection systems of these two patents require that the original equipment manufacturer (“OEM”) or unarmored HMMWV be substantially altered or modified to install the armor and blast shields to the vehicle. As such, the armor and blast shields of these two patents cannot simply be removed and the HMMWV thereby returned to its OEM or unarmored state.

A HMMWV may not always be deployed in a wartime setting where it is exposed to lethal threats. It may also be deployed in a peacetime setting. In that case it is desirable to remove the lethal threat protection system so as to not burden the vehicle with the lethal threat protection system over the vehicle's entire useful life. This is because burdening the vehicle with a permanently installed lethal threat protection system can increase the costs of vehicle maintenance and generally decrease the service life of the vehicle.

One solution to this problem is shown and described in the assignee's U.S. Pat. No. 7,695,053, hereby incorporated by reference herein. In this patent a lethal threat protection system for the HMMWV is shown and described that includes separate A pillar armor, B pillar armor, C pillar armor, and rocker panel armor, along with armored front and rear doors, that can be installed on, and without modification to, the OEM or unarmored vehicle, and that can then be readily removed as the need dictates. Unlike previous lethal threat protection systems, this lethal threat protection does not require the OEM vehicle to be substantially altered or modified to install the lethal threat protection system. Thus, once the lethal threat protection system is removed from the vehicle, the vehicle is returned to its OEM or unarmored state for peacetime duty.

Despite the advancements made in the area of lethal threat protection for the HMMWV, there is still room for improvement. For example, the multiple pieces of armor of U.S. Pat. No. 7,695,053 can be time consuming to install and remove and can create seams or gaps that can reduce the integrity of the armor system.

### SUMMARY

In one aspect, a lethal threat protection system for a vehicle, each side of the vehicle having an A pillar and a B pillar and a vehicle body positioned outwardly of the A pillar and the B pillar, the vehicle including a rocker panel area below and spanning between the A and B pillars and including a roof line area above and spanning between the A and B pillars, comprises a perimeter inner layer adapted to be mounted to the vehicle body and comprising an inner monolithic ballistic metal plate having a door opening and including portions adapted to overlie the A pillar, the B pillar, the rocker panel area, and the roof line area, a perimeter outer layer removably mounted to the perimeter inner layer and comprising an outer monolithic ballistic metal plate having a door opening and including portions overlying the portions of the inner monolithic ballistic metal plate, the perimeter outer layer further comprising ballistic fiber secured to an inner surface of the outer monolithic ballistic metal plate, and an armored door mounted to the outer monolithic ballistic metal plate.

The inner monolithic ballistic metal plate and the outer monolithic ballistic metal plate can be fabricated from aluminum and the ballistic fiber can be ultra high molecular weight polyethylene. Alternatively the outer monolithic ballistic metal plate can be fabricated from steel. One preferred construction is for the inner monolithic ballistic metal plate and the outer monolithic ballistic metal plate to be fabricated from ⅜″ thick 2139 aluminum alloy and for the ballistic fiber to be 2¼″ thick ultra high molecular weight polyethylene. Another preferred construction is for the outer monolithic ballistic metal plate to be fabricated from ⅜″ thick 2139 aluminum alloy, for the inner monolithic ballistic metal plate to be fabricated from ⅛″ thick- 3/16″ thick Mil Spec 46177 or 46100 steel, and for the ballistic fiber to be 2¼″ thick ultra high molecular weight polyethylene. The armored door can also be of a similar construction and comprise an inner ballistic metal plate, an intermediate layer of ballistic fiber, and an outer ballistic metal plate. The inner ballistic metal plate and the outer ballistic metal plate of the armored door can also be fabricated from aluminum and the ballistic fiber of the door can also be ultra high molecular weight polyethylene. One preferred construction of the armored door is for the inner ballistic metal plate and the outer ballistic metal plate to be fabricated from ⅜″ thick 2139 aluminum alloy and for the ballistic fiber to be 2¼″ thick ultra high molecular weight polyethylene. Another preferred construction is for the outer ballistic metal plate to be fabricated from ⅜″ thick 2139 aluminum alloy, for the inner ballistic metal plate to be fabricated from ⅛″ thick- 3/16″ thick Mil Spec 46177 or 46100 steel, and for the ballistic fiber to be 2¼″ thick ultra high molecular weight polyethylene. The armored door can further comprise an inner layer of ballistic fiber secured to an inner surface of the inner ballistic metal plate, and a layer of insulation secured to an inner surface of the inner layer of ballistic fiber.

Each side of the vehicle can further have a C pillar, the vehicle body positioned outwardly of the A, B, and C pillars, the rocker panel area being below and spanning between the A and C pillars and the roof line area being above and spanning between the A and C pillars, the inner monolithic ballistic metal plate having a front door opening and a rear door opening and including portions adapted to overlie the A pillar, the B pillar, the C pillar, the rocker panel area, and the roof line area, the outer monolithic ballistic metal plate having a front door opening and a rear door opening and including portions overlying the portions of said inner monolithic ballistic metal plate. The system can then include a front armored door and a rear armored door; the front armored door can be hinged along a front vertical edge thereof to the outer monolithic ballistic metal plate, and the rear armored door can be hinged along a rear vertical edge thereof to the outer monolithic ballistic metal plate.

The lethal threat protection system can further comprise an unarmored door for mounting to the perimeter inner layer once the perimeter outer layer has been removed from the perimeter inner layer.

In another aspect, a method of configuring a vehicle in wartime and peacetime configurations, each side of the vehicle having an A pillar and a B pillar and a vehicle body positioned outwardly of the A pillar and the B pillar, the vehicle including a rocker panel area below and spanning between the A and B pillars and including a roof line area above and spanning between the A and B pillars, comprises the steps of providing a perimeter inner layer adapted to be mounted to the vehicle body and comprising an inner monolithic ballistic metal plate having a door opening and including portions adapted to overlie the A pillar, the B pillar, the rocker panel area, and the roof line area, providing a perimeter outer layer comprising an outer monolithic ballistic metal plate having a door opening and including portions overlying the portions of the perimeter inner layer, the perimeter outer layer further comprising ballistic fiber secured to an inner surface of the outer monolithic ballistic metal plate, the perimeter outer layer further comprising an armored door mounted to the outer monolithic ballistic metal plate, and providing an unarmored door, mounting the perimeter inner layer to the vehicle body, mounting the perimeter outer layer to the perimeter inner layer to place the vehicle in the wartime configuration, removing the perimeter outer layer and mounting the unarmored door to the perimeter inner layer to place the vehicle in the peacetime configuration.

The method can further comprise the steps of providing the inner monolithic ballistic metal plate and the outer monolithic ballistic metal plate fabricated from aluminum and providing the ballistic fiber fabricated from ultra high molecular weight polyethylene. The method can further comprise the step of providing the armored door as comprising an inner ballistic metal plate, an intermediate layer of ballistic fiber, and an outer ballistic metal plate. The method can further comprise the steps of providing the inner ballistic metal plate and the outer ballistic metal plate fabricated from aluminum and providing the ballistic fiber fabricated from ultra high molecular weight polyethylene.

### DRAWINGS

FIG. 1 is an exploded perspective view of a prior art lethal threat protection system for the HMMWV.

FIG. 2 is an exploded perspective view of the instant lethal threat protection system.

FIG. 3A is an enlarged exploded perspective view of the instant lethal threat protection system in wartime configuration.

FIG. 3B is an enlarged exploded perspective view of the instant lethal threat protection system in peacetime configuration.

FIG. 4 is an enlarged assembled perspective view of the instant lethal threat protection system in wartime configuration.

FIG. 5 is a side view of the vehicle of FIG. 4.

FIG. 6 is a front view of the vehicle of FIGS. 4 and 5.

FIG. 7A is a cross-sectional view of the perimeter outer layer being mounted onto the perimeter inner layer.

FIG. 7B is a cross-sectional view of the perimeter outer layer mounted on the perimeter inner layer.

FIG. 7C is a cross-sectional view of the perimeter outer layer being removed from the perimeter inner layer.

FIG. 7D is a cross-sectional view of the unarmored door being mounted on the perimeter inner layer.

FIG. 7E is a cross-sectional view of the unarmored door mounted on the perimeter inner layer.

### DESCRIPTION

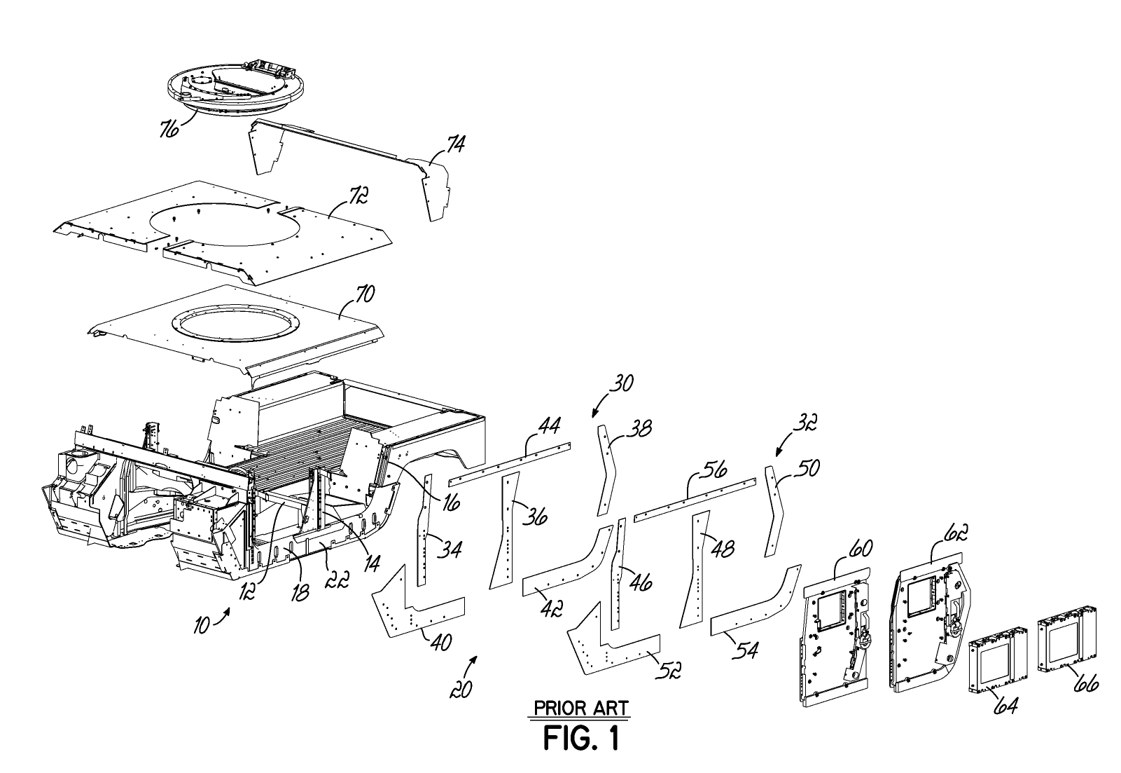

Referring first to FIG. 1 there is illustrated an OEM or otherwise unarmored HMMWV 10 and a prior art lethal threat protection system 20 therefore. The HMMWV 10 includes an A pillar 12, a B pillar 14, and a C pillar 16 on either side of the HMMWV 10. A vehicle body 18 is positioned outwardly of the A, B, and C pillars 12, 14, and 16. The vehicle has a rocker panel area or region 22 below and spanning between the A and B pillars and the B and C pillars, and a roof line area or region 24 above and spanning between the A and B pillars and the B and C pillars.

The prior art lethal threat protection system 20 includes a 6 part perimeter inner layer 30 and a 6 part perimeter outer layer 32. Inner layer 30 is fabricated of steel and includes separate A pillar armor 34, B pillar armor 36, C pillar armor 38, rocker panel armor 40, 42, and roof line armor 44. Similarly, outer layer 32 includes separate A pillar armor 46, B pillar armor 48, C pillar armor 50, rocker panel armor 52, 54, and roof line armor 56, though fabricated of aluminum. Front and rear armored doors 60, 62 include armored windows 64, 66, respectively. The system 20 further includes inner and outer roof layers 70, 72, shoulder armor 74, and turret 76.

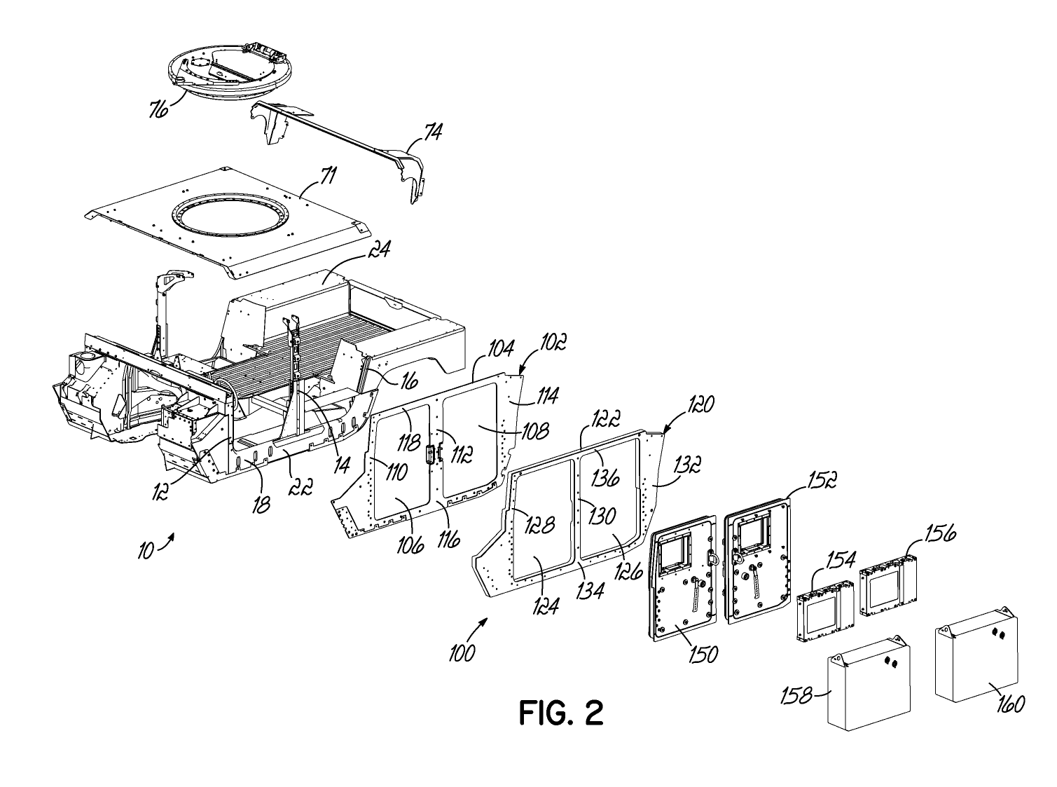

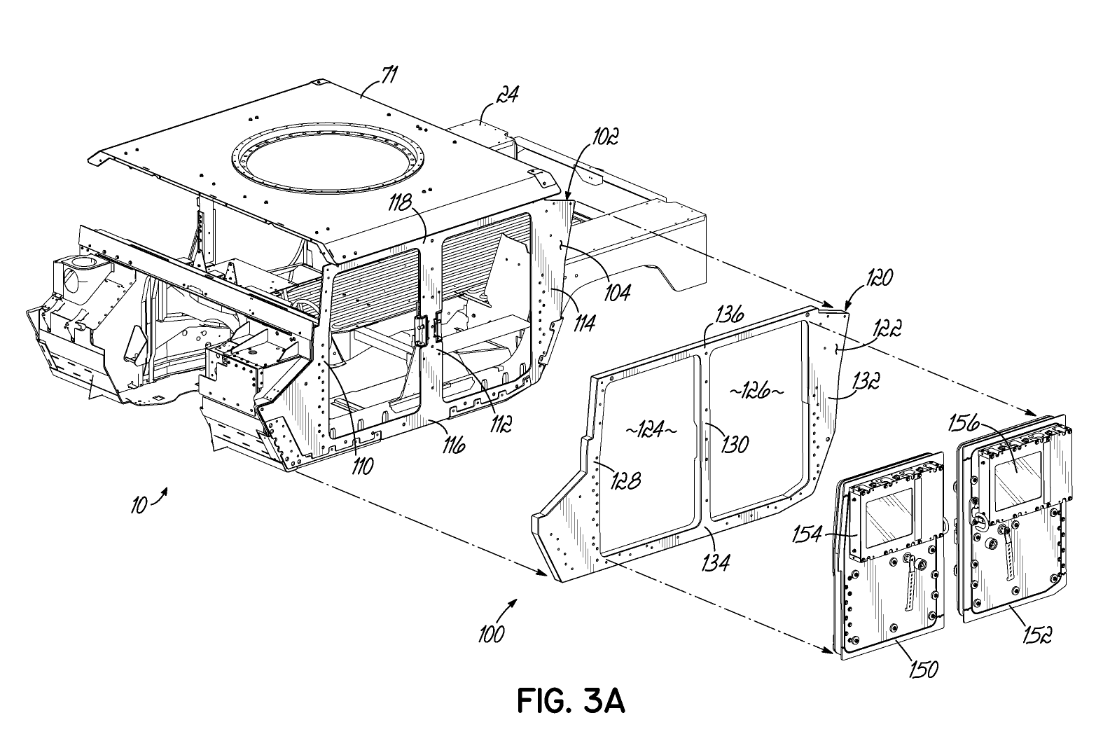

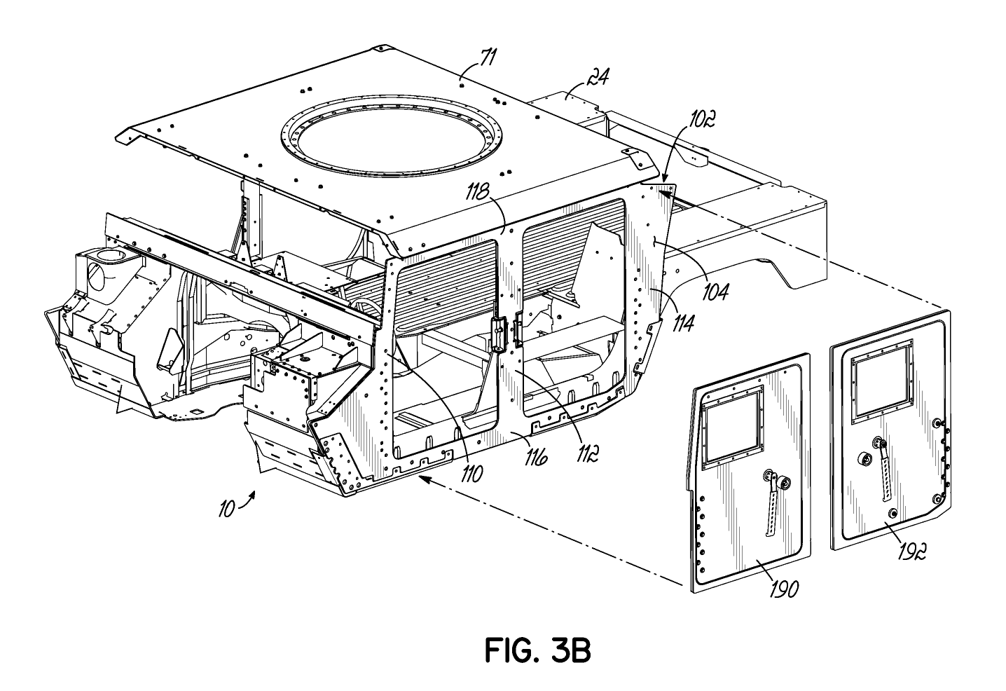

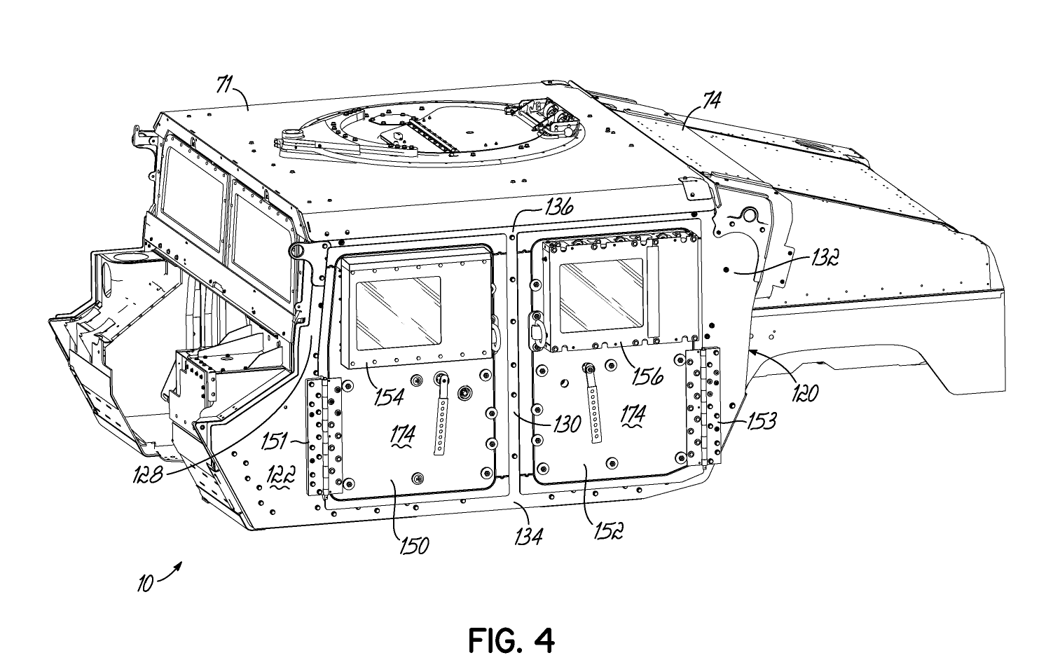

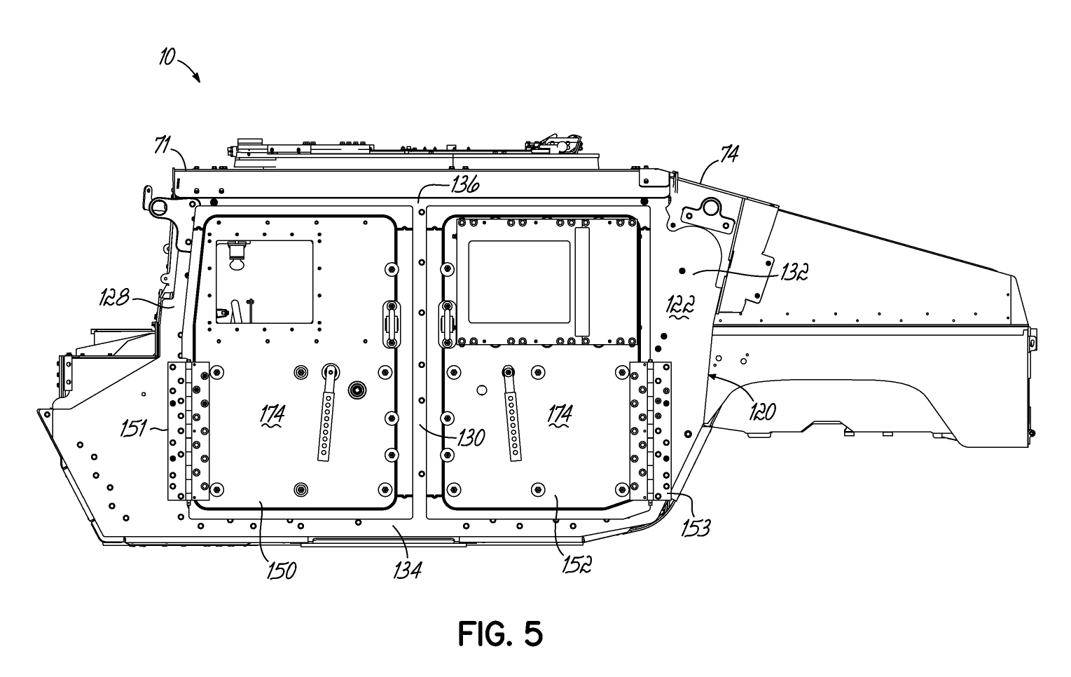

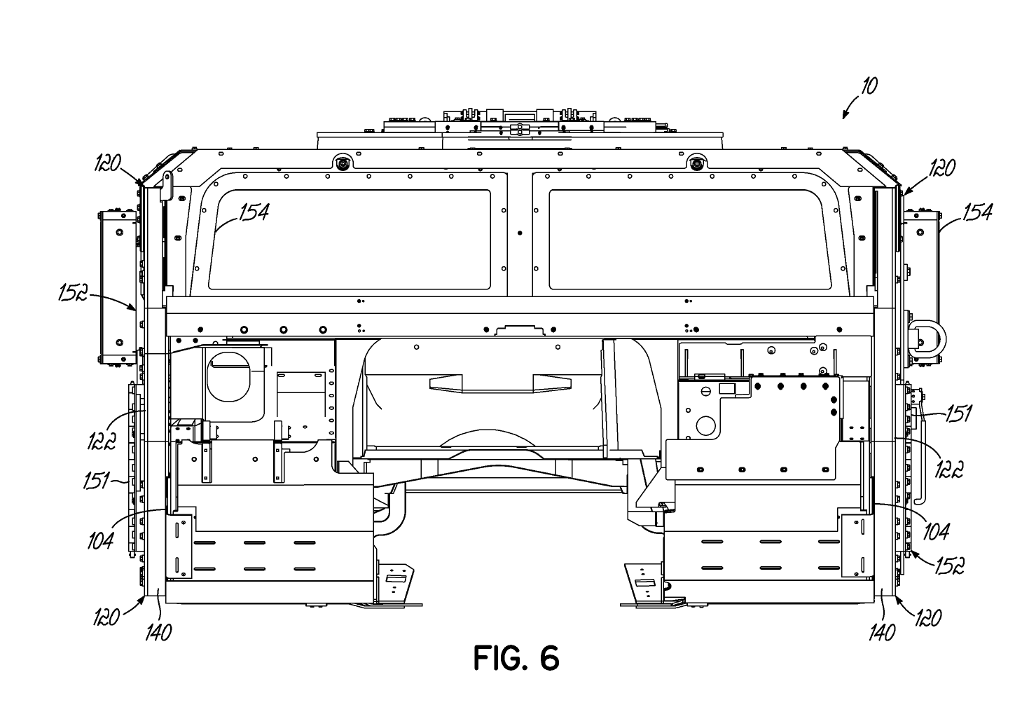

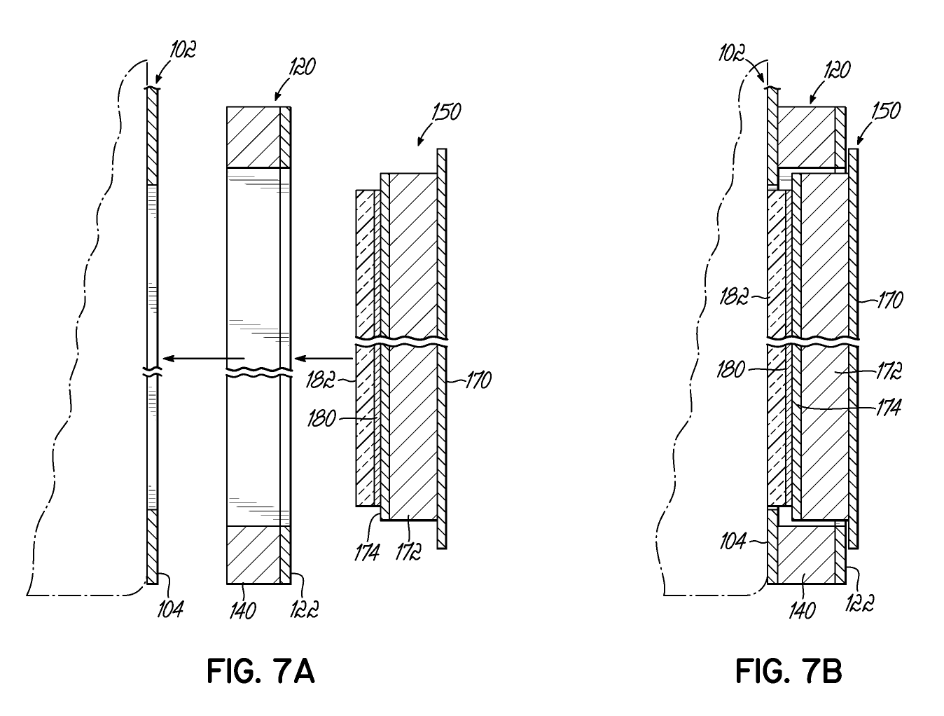

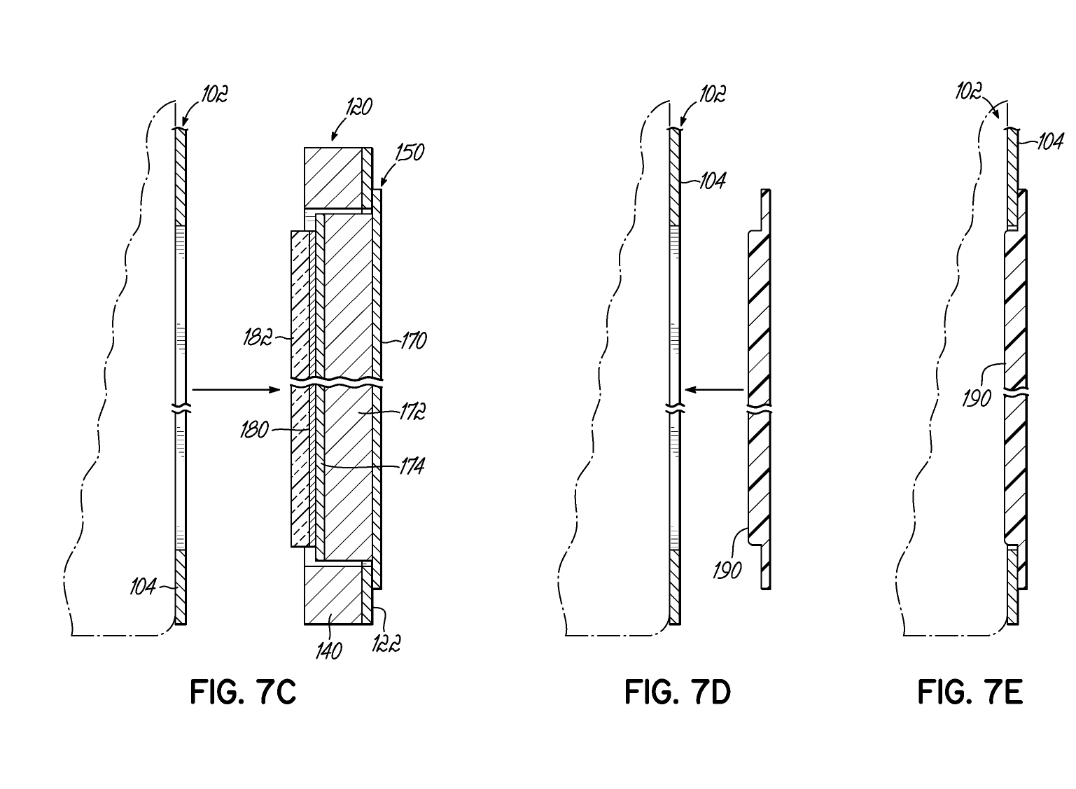

The wartime configuration of vehicle 10 is shown in FIGS. 2 and 3A, whereas the peacetime configuration of the vehicle 10 is shown in FIG. 3B. Referring to FIG. 2, the instant lethal threat protection system 100 is illustrated. The system 100 comprises a perimeter inner layer 102 adapted to be mounted to the vehicle body 18 with, for example bolts, and comprising an inner monolithic ballistic metal plate 104 having a front door opening 106, rear door opening 108, and including portions 110, 112, 114, 116, and 118 adapted to overlie the A pillar 12, the B pillar 14, the C pillar 16, the rocker panel area 22, and the roof line area 24. Monolithic ballistic metal plate 104 is made from a single sheet of metal and as such has no seems, joints, etc. A perimeter outer layer 120 is removably mounted to the perimeter inner layer 102 with, for example bolts, and comprises an outer monolithic ballistic metal plate 122 having a front door opening 124, a rear door opening 126, and including portions 128, 130, 132, 134, 136 overlying the above-mentioned portions 110, 112, 114, 116, and 118 of the inner monolithic ballistic metal plate 104. Inner monolithic ballistic metal plate 104 is made from a single sheet of metal and as such has no seems, joints, etc. The perimeter outer layer 120 further comprises ballistic fiber 140 secured, for example bonded or adhesively secured, to an inner surface of the outer monolithic ballistic metal plate 122. See FIGS. 7A-7C. Completing the perimeter outer layer 120 are armored front and rear doors 150, 152 mounted to outer monolithic ballistic metal plate 122 with, for example hinges and bolts, and which can include armored window boxes 154, 156, respectively, and armored EFP boxes 158, 160 respectively. Doors 150, 152 can be hinged “suicide” fashion to outer monolithic ballistic metal plate 122, i.e. front door 150 has a hinge 151 that is hinged to front edge of front door opening 124 and rear door 152 has a hinge 153 that is hinged to rear edge of rear door opening 126, to provide better clearance for opening the doors during ingress and egress. The system 100 can have a single layer roof 71 of, for example, 3.3-3.5 mm 500 brinell steel.

The inner monolithic ballistic metal plate 104 and the outer monolithic ballistic metal plate 122 can be fabricated from aluminum and the ballistic fiber 140 can be ultra high molecular weight polyethylene. Alternatively the inner monolithic ballistic metal plate 104 can be fabricated from aluminum and the outer monolithic ballistic metal plate 122 can be fabricated from steel, or the inner monolithic ballistic metal plate 104 can be fabricated from steel and the outer monolithic ballistic metal plate 122 can be fabricated from aluminum, or both the inner and outer monolithic ballistic metal plates 104, 122 can be fabricated from steel, or one or both can be fabricated from titanium in combination with aluminum or steel for the other. One preferred construction is for the inner monolithic ballistic metal plate 104 and the outer monolithic ballistic metal plate 122 to be fabricated from ⅜″ thick 2139 aluminum alloy and for the ballistic fiber to be 2¼″ thick ultra high molecular weight polyethylene. Another preferred construction is for the outer monolithic ballistic metal plate 122 to be fabricated from ⅜″ thick 2139 aluminum alloy, for the inner monolithic ballistic metal plate 104 to be fabricated from ⅛″ thick- 3/16″ thick Mil Spec 46177 or 46100 steel, and for the ballistic fiber to be 2¼″ thick ultra high molecular weight polyethylene. One type of ultra high molecular weight polyethylene that can be used is TENSYLON, available from the assignee. Inner monolithic ballistic metal plate 104 can further comprise an inner layer of ballistic fiber or “spall liner” (not shown), for example an aramid fiber such as KEVLAR, secured to an inner surface thereof, and a layer of insulation (not shown) secured to an inner surface of the inner layer of ballistic fiber.

The armored doors 150, 152 can also be of a similar construction and comprise an inner ballistic metal plate 170, an intermediate layer of ballistic fiber 172, and an outer ballistic metal plate 174. See FIGS. 7A-7C. The inner ballistic metal plate 170 and the outer ballistic metal plate 174 of the armored doors 150, 152 can also be fabricated from aluminum and the ballistic fiber 172 of the doors 150, 152 can also be ultra high molecular weight polyethylene. Alternatively the inner ballistic metal plate 170 can be fabricated from aluminum and the outer ballistic metal plate 174 can be fabricated from steel, or the inner ballistic metal plate 170 can be fabricated from steel and the outer ballistic metal plate 174 can be fabricated from aluminum, or both the inner and outer ballistic metal plates 170, 174 can be fabricated from steel, or one or both can be fabricated of titanium in combination with aluminum or steel for the other. One preferred construction of the armored doors 150, 152 is for the inner ballistic metal plate 170 and the outer ballistic metal plate 174 to be fabricated from ⅜″ thick 2139 aluminum alloy and for the ballistic fiber 172 to be 2¼″ thick ultra high molecular weight polyethylene. Another preferred construction of the armored doors 150, 152 is for the outer ballistic metal plate 174 to be fabricated from ⅜″ thick 2139 aluminum alloy, for the inner ballistic metal plate 170 to be fabricated from ⅛″ thick- 3/16″ thick Mil Spec 46177 or 46100 steel, and for the ballistic fiber 172 to be 2¼″ thick ultra high molecular weight polyethylene. One type of ultra high molecular weight polyethylene that can be used is TENSYLON, available from the assignee. The armored doors 150, 152 can further comprise an inner layer of ballistic fiber 180 or “spall liner,” for example an aramid fiber such as KEVLAR, secured to an inner surface of the inner ballistic metal plate 170, and a layer of insulation 182 secured to an inner surface of the inner layer of ballistic fiber 180. Lightweight unarmored doors 190, 192 fabricated from, for example aluminum or fiberglass, and including standard non-ballistic automotive window glass, can be mounted to the perimeter inner layer 102 once the perimeter outer layer 120 has been removed from the perimeter inner layer 102 thereby placing the HMMWV 10 in a peacetime configuration. See FIGS. 3B, 7D, and 7E.

Referring to FIGS. 7A-7E, in use inner plate 104 of perimeter inner layer 102 is first bolted to vehicle 10. To configure vehicle 10 for wartime, armored doors 150, 152 are bolted to outer plate 122 of perimeter outer layer 120, and perimeter outer layer 120 is then bolted to perimeter inner layer 102. To configure vehicle 10 for peacetime, perimeter outer layer 120 is removed from perimeter inner layer 102 and peacetime doors 190, 192 are bolted to perimeter inner layer 102.

The monolithic design of the perimeter inner and outer layers reduces the time required to install and remove the armor system thus permitting rapid re-configuration of the vehicle from peacetime configuration to wartime configuration and back. Further, the monolithic design of the perimeter inner and outer layers eliminates seams or gaps in prior art armoring systems thereby increasing the integrity of the armor system. Yet further, the three layer armoring solution of the perimeter and the armored doors results in a substantial weight savings over the prior art armoring system.

The embodiments shown and described are merely for illustrative purposes only. The drawings and the description are not intended to limit in any way the scope of the claims. Those skilled in the art will appreciate various changes, modifications, and other embodiments. All such changes, modifications and embodiments are deemed to be embraced by the claims. Accordingly, the scope of the right to exclude shall be limited only by the following claims and their equivalents.

What is claimed is:

1. A lethal threat protection system for a vehicle, each side of the vehicle having an A pillar and a B pillar and a vehicle body positioned outwardly of the A pillar and the B pillar, the vehicle including a rocker panel area below and spanning between the A and B pillars and including a roof line area above and spanning between the A and B pillars, said lethal protection system comprising:
a perimeter inner layer adapted to be mounted to the vehicle body and comprising an inner monolithic ballistic metal plate having a door opening and including portions adapted to overlie the A pillar, the B pillar, the rocker panel area, and the roof line area,
a perimeter outer layer removably mounted to said perimeter inner layer and comprising an outer monolithic ballistic metal plate having a door opening and including portions overlying said portions of said inner monolithic ballistic metal plate, said perimeter outer layer further comprising ballistic fiber secured to an inner surface of said outer monolithic ballistic metal plate, and
an armored door mounted to said outer monolithic ballistic metal plate.

2. The lethal threat protection system of claim 1 wherein said inner monolithic ballistic metal plate and said outer monolithic ballistic metal plate are fabricated from aluminum and said ballistic fiber is ultra high molecular weight polyethylene.

3. The lethal threat protection system of claim 1 wherein said inner monolithic ballistic metal plate is fabricated from aluminum, said outer monolithic ballistic metal plate is fabricated from steel, and said ballistic fiber is ultra high molecular weight polyethylene.

4. The lethal threat protection system of claim 1 wherein said inner monolithic ballistic metal plate and said outer monolithic ballistic metal plate are fabricated from ⅜″ thick 2139 aluminum alloy and said ballistic fiber is 2¼″ thick ultra high molecular weight polyethylene.

5. The lethal threat protection system of claim 1 wherein said armored door comprises an inner ballistic metal plate, an intermediate layer of ballistic fiber, and an outer ballistic metal plate.

6. The lethal threat protection system of claim 5 wherein said inner ballistic metal plate and said outer ballistic metal plate are fabricated from aluminum and said ballistic fiber is ultra high molecular weight polyethylene.

7. The lethal threat protection system of claim 6 wherein said inner ballistic metal plate and said outer ballistic metal plate are fabricated from ⅜″ thick 2139 aluminum alloy and said ballistic fiber is 2¼″ thick ultra high molecular weight polyethylene.

8. The lethal threat protection system of claim 7 wherein said armored door further comprises an inner layer of ballistic fiber secured to an inner surface of said inner ballistic metal plate, and a layer of insulation secured to an inner surface of said inner layer of ballistic fiber.

9. The lethal threat protection system of claim 1 wherein each side of the vehicle further has a C pillar, the vehicle body positioned outwardly of the A, B, and C pillars, the rocker panel area being below and spanning between the A and C pillars and the roof line area being above and spanning between the A and C pillars, said inner monolithic ballistic metal plate having a front door opening and a rear door opening and including portions adapted to overlie the A pillar, the B pillar, the C pillar, the rocker panel area, and the roof line area, said outer monolithic ballistic metal plate having a front door opening and a rear door opening and including portions overlying said portions of said inner monolithic ballistic metal plate.

10. The lethal threat protection system of claim 1 further comprising an unarmored door for mounting to said perimeter inner layer once said perimeter outer layer has been removed from said perimeter inner layer.

11. The lethal threat protection system of claim 9 further comprising a front and a rear said armored door, said front armored door hinged along a front vertical edge thereof to said outer monolithic ballistic metal plate, said rear armored door hinged along a rear vertical edge thereof to said outer monolithic ballistic metal plate.

12. A method of configuring a vehicle in wartime and peacetime configurations, each side of the vehicle having an A pillar and a B pillar and a vehicle body positioned outwardly of the A pillar and the B pillar, the vehicle including a rocker panel area below and spanning between the A and B pillars and including a roof line area above and spanning between the A and B pillars, the method comprising the steps of:
providing a perimeter inner layer adapted to be mounted to the vehicle body and comprising an inner monolithic ballistic metal plate having a door opening and including portions adapted to overlie the A pillar, the B pillar, the rocker panel area, and the roof line area,
providing a perimeter outer layer comprising an outer monolithic ballistic metal plate having a door opening and including portions overlying the portions of the perimeter inner layer, the perimeter outer layer further comprising ballistic fiber secured to an inner surface of the outer monolithic ballistic metal plate, the perimeter outer layer further comprising an armored door mounted to the outer monolithic ballistic metal plate, and
providing an unarmored door,
mounting the perimeter inner layer to the vehicle body,
mounting the perimeter outer layer to the perimeter inner layer to place the vehicle in the wartime configuration,
removing the perimeter outer layer and mounting the unarmored door to the perimeter inner layer to place the vehicle in the peacetime configuration.

13. The method of claim 11 further comprising the steps of providing the inner monolithic ballistic metal plate and the outer monolithic ballistic metal plate fabricated from aluminum and providing the ballistic fiber fabricated from ultra high molecular weight polyethylene.

14. The method of claim 11 further comprising the step of providing the armored door as comprising an inner ballistic metal plate, an intermediate layer of ballistic fiber, and an outer ballistic metal plate.

15. The method of claim 13 further comprising the steps of providing the inner ballistic metal plate and the outer ballistic metal plate fabricated from aluminum and providing the ballistic fiber fabricated from ultra high molecular weight polyethylene.

16. The lethal threat protection system of claim 1 wherein said inner monolithic ballistic metal plate is fabricated from steel, said outer monolithic ballistic metal plate is fabricated from aluminum, and said ballistic fiber is ultra high molecular weight polyethylene.

17. The lethal threat protection system of claim 5 wherein said inner ballistic metal plate is fabricated from steel, said outer ballistic metal plate is fabricated from aluminum, and said ballistic fiber is ultra high molecular weight polyethylene.

18. The method of claim 13 further comprising the steps of providing the inner ballistic metal plate fabricated from steel, providing the outer ballistic metal plate fabricated from aluminum, and providing the ballistic fiber fabricated from ultra high molecular weight polyethylene.
